(19) United States
(12) Patent Application Publication
(10) Pub. No.: US 2020/0100524 A1
(43) Pub. Date: Apr. 2, 2020

(54) SOLUBLE PEA PROTEIN PRODUCTS

(71) Applicants: World Food Holdings, LLC, Oskaloosa, IA (US); Puris Proteins, LLC, Minneapolis, MN (US)

(72) Inventors: Alexander Edward King, Apple Valley, MN (US); Dakota Rose Novak, Forest Lake, MN (US); John Thomas Phillips, Minneapolis, MN (US); Nicole Ann Atchison, Eden Prairie, MN (US); Kushal Narayan Chandak, Minneapolis, MN (US)

(21) Appl. No.: 16/588,935

(22) Filed: Sep. 30, 2019

Related U.S. Application Data
(60) Provisional application No. 62/739,697, filed on Oct. 1, 2018.

(51) Int. Cl. A23J 1/14; A23J 3/28; A21D 13/066; A21D 13/80; A21D 13/45; A23L 2/66; A23L 23/00; A23G 9/38; A23L 2/54; A23J 3/34

(52) U.S. Cl. CPC A23J 1/148; A23J 3/28; A21D 13/066; A21D 13/80; A21D 13/45; A23V 2002/00; A23L 23/00; A23G 9/38; A23L 2/54; A23J 3/346; A23L 2/66

(57) ABSTRACT

The present disclosure relates to unique soluble pea protein product can be used alone to make aerated bakery products, confections, desserts, sauces, and beverages. The soluble pea protein product can be combined with insoluble pea protein product to make a range of food products with higher protein content than when insoluble, globular pea protein product is used alone, due to the viscosity reducing nature of the soluble pea protein product when it is combined with insoluble globular pea protein product. The soluble pea protein products when combined with insoluble pea protein products, make a resulting pea protein product that has a PDCAAS of about 0.75-1.00. The process to make this unique soluble pea protein includes means of selectively separating the soluble pea protein product from the insoluble fractions of ground peas, as well as selectively separating the soluble pea protein from soluble carbohydrates and ash. This Abstract is not intended to identify key features or essential features of subject matter, nor does this Abstract intend to be used to limit the scope of claimed subject matter.

### CROSS-REFERENCE TO RELATED APPLICATIONS

The application claims the benefit of U.S. Provisional Patent Application No. 62/739,697 filed Oct. 1, 2018, entitled “Soluble Pea Protein Products”, which is hereby incorporated by reference in its entirety as if fully restated herein.

### BACKGROUND

The present disclosure is broadly concerned with a soluble pea protein product and the uses of such in food products that are nutritious, palatable, and gluten free, as well as optionally high in protein content. The soluble pea protein product of this disclosure can be used to make food products with the texture and flavor desired by consumers, while meeting the consumers' nutritional and labeling wants and needs for allergen free food products. Embodiments of the current disclosure include means to make “complete” pea protein products which have a PDCAAS of .90-1.0. PDCAAS means Protein Digestibility Corrected Amino Acid Score.

Protein is a key nutrient needed for healthy bodies. As such protein is a key ingredient in many food products. In general, proteins have many physiochemical functions, including aeration control, viscosity control, suspension control, solubility control, and bulk. The functionality of a protein can be affected by the source of the protein (e.g., animal or plant and which animal or plant) and by the processing conditions used to extract and separate the protein from its source.

Not all proteins are functionally and chemically alike. Proteins are made up of amino acids, the amount of which can be different for each source and type of protein. Proteins, in part because of their amino acid content, can be of different physical geometric types that can lead to different physiochemical functional abilities. Differences in amino acid content can also affect how “complete” the protein is as determined by Food and Drug Administration (“FDA”) in their PDCAAS methodology (PDCAAS means Protein Digestibility-Corrected Amino Acid Score and is a method of evaluating the quality of a protein based on both the amino acid requirements of humans and their ability to digest it). Under FDA regulations casein is considered to be “complete” protein with a PDCAAS score of 1.0. The PDCAAS is the means by which FDA regulations allow ingredient and food product manufacturers to communicate the amount of protein and the “quality” of that protein as % Daily Value (“% DV”) on an ingredient's or food product's Nutrition Data Panel.

As already discussed, not all proteins are functionally and chemically alike. Proteins, because of their amino acid content, can be of different physical geometric types, such as globular, semi-linear and less-globular, or combinations of both. Not to be limited by theory, the physical geometric types can lead to different functional abilities as each geometry will lead to exposure of different amino acids, so different numbers of reactive sites. This factor of geometric types effects protein's ability to control aeration (i.e., reaction between gasses, fluids, and solids), control viscosity (i.e., reaction between fluids and solids), control suspension (i.e., reaction between fluids and solids), and control solubility (i.e., reaction between fluids and solids). Of course the actual amino acids present in the protein will effect these same functional properties of the protein. Herein globular refers to the physical structure of the insoluble pea protein form and semi-linear, less-globular refers to the physical structure of the soluble pea protein form. The insoluble (globular) pea protein product has a larger molecular weight than the soluble (semi-liner) pea protein product. Insoluble pea protein products are at least partially insoluble at room temperature and pH 4.5-6.5. Soluble pea protein products are at least 50% soluble at room temperature and pH 4.5-6.5.

A combined soluble and insoluble pea protein product contains both soluble pea protein product and insoluble pea protein product at room temperature and pH 4.5-6.5. It can be made by: a) making a water insoluble pea protein product; b) making a water soluble pea protein product; and c) combining water insoluble pea protein product and water soluble pea protein.

The most common methods of pea protein extraction (i.e., separation) from harvested, hulled peas creates a pea protein with an amino acid content and arrangement that leads to the pea protein being insoluble in water that has a theoretically roughly condensed globular geometric type. The developers of the current disclosure did an analysis of the fluid by-products of the separation process that created the insoluble globular pea protein product, and detected the presence of additional protein content. These proteins were identified as being soluble under the separation processing conditions, and they were smaller in molecular weight than the insoluble proteins. Based on theory, the developers of this disclosure thought that these soluble proteins would be roughly semi-linear and less-globular in geometric type than the larger proteins. Amino acid analysis data of the insoluble pea protein product and of the soluble pea protein product showed that their amino acid contents differed.

The pea separation process creates protein products, as well as carbohydrates products. These carbohydrate products include fiber from the pea hull, fiber from the seed, starch from the seed, and small molecular weight oligosaccharides from the seed. Each of these products have physiochemical properties of interest to product developers.

There is a growing consumer trend towards diets with higher protein content, usually through food products with boosted protein contents. High protein diets have been shown to have a number of health benefits, including but not limited to, aid in maintaining weight, aid in stabilizing blood sugar levels, and aid in ability to learn and concentrate. High levels of protein in foods also leads to satiation at lower calorie content. Protein is the building blocks for both bone and muscles, and as such, protein is important to every cell in the body. One challenge of increasing the protein content of many food products is the thickening properties and limited solubility of globular pea protein. There are current limits as to how much protein can be added when it is in the globular geometric form.

There is a growing consumer trend towards food products with no gluten content. Gluten is a combination of two proteins (gliadin and glutenin) in wheat. Many consumers have, or believe they might have, celiac disease. Celiac disease is a chronic digestive disorder resulting from an immune reaction to gliadin. This involves inflammation and destruction of the inner lining of the small intestine, which can lead to the malabsorption of minerals and nutrients. Such a disease brings on symptoms that include gastro irritation when products containing gluten are consumed. For this reason, there is a growing interest by consumers for food products with the texture and flavor they expect with traditional food products usually made with wheat flour, but without wheat flour. Wheat flour includes gluten, which has the key functions of viscosity building and aeration control in bakery products, sauces, and gravies.

Interest in food products containing pea protein products is also in part because there is a growing consumer trend against food products containing allergens. The top eight allergens according to FDA include: wheat, soy, milk, eggs, fish, crustacean shellfish, tree nuts, and peanuts. The inclusion of any of these allergens require listing such content (or even possible content) on product labels. Elimination of these ingredients causes a challenge for food product formulators because wheat proteins, milk proteins, egg proteins, and soy proteins have excellent functional properties including viscosity and aeration control.

Consumers on vegan diets (also called plant-based diets) are interested in foods made with pea proteins because they are avoiding food products that contain animal based proteins, which include proteins from egg, meat (including gelatin), and milk sources. The avoidance of gelatin containing products by some consumers can also be attributed to religious dietary laws, as its source is usually from meat (especially pork). Gelatin from fish might meet religious dietary laws, but is avoided by product developers because of its usual “fishy” flavor notes. As proteins provide the means for absorbing and maintaining water content with a wide range of food products, the lack of the use of these traditional proteins can create product defects such as too soft texture and poor water content maintenance.

Many consumers also avoid food products with milk based protein ingredients due to fear of lactose content as they are, or believe they could be, intolerant to lactose. For many consumers, lactose can cause them digestive disturbances such as cramps and diarrhea.

Consumers are growing more cautious on what they eat, and not just because of allergen avoidance. There is a growing trend for consumers to read product labels before they purchase food products. They are looking for “clean labels”. Though “clean label” is not a FDA or USDA labeling regulation, “clean label” commonly means inclusion in product ingredient statements and/or on food label panels no ingredients that sound synthetic or highly manufactured (such as emulsifiers, surfactants, and hydrocolloids), and no ingredients that would be unexpected (such as hydrocolloids, artificial flavors and colors). Pea protein products are of interest, in part, because they can be used as replacement materials for these emulsifiers, surfactants, and hydrocolloids in many food products. “Clean label” also often means using non-GMO, natural, and/or certified organic ingredients. With more and more detail being placed on restaurant menus and advertisement, manufacturers are getting cautious with what they deliver directly and indirectly to the consumer.

The proteins discussed in this disclosure are from pulses, especially peas. Pulses are non-soybean, non-peanut legumes. Pulses include, but are not limited to, peas, beans, lentils, and chickpeas. As used herein, “pea” means the mostly small spherical seed of the pod fruit Pisum sativum. In particular, the pea used in this disclosure is from varieties of the species typically called field peas, yellow peas, or wrinkled peas that are grown to produce dry peas that are shelled from the mature pod. Peas have been harvested as human food as far back as the early third century BC. Peas are traditional foods in the diets of people living on every continent, most particularly in European, Asian, North African and North American countries. Though traditionally a cool-season crop, new varieties have been bred that can be grown in hotter climates and also in dryer climates. Peas also have been breed to contain a range of physiological characteristics. These breeding practices, as well as the cultural eating histories of so many people, make peas an excellent source for protein, fiber, and carbohydrates for many consumers world-wide.

Peas as traditionally harvested and dried, have a hull portion (about 6-10% dwt. of whole pea) and a seed portion (about 90-94% dwt of whole pea). When the hull is removed the content of the resulting hull material includes mostly fiber, but also some protein and starch. The hull portion of the pea may be removed from the whole pea by a number of processes, which can be done by various methods known in the art. These methods include, but are not limited to dry and wet milling. The pea products (i.e., protein products, fiber products, carbohydrate products) of this disclosure are not limited by the specific purity of the pea products. Embodiments of this disclosure include pea protein products that contain some pea fiber or carbohydrate in them.

Preferably, the peas used to produce the soluble, insoluble, and combined soluble and insoluble pea protein products, as well as the fiber and carbohydrate products, of this disclosure are non-GMO according to project verified non-GMO and by FDA regulations. Preferably, the various pea products of this disclosure are from peas that are naturally breed and not genetically created, and are Organic Certified according to USDA regulations.

Non-GMO means not genetically modified. FDA.gov website currently includes guidance for manufacturers who wish to voluntarily label food as containing or not-containing genetically engineered ingredients. Additional label regulations as to mandatory labeling or foods containing genetically engineered ingredients are being developed for enforcement starting roughly 2020. Under these regulations, traditional breeding of pulse plants would be free of genetic engineering.

Organic Certified means that the source of the ingredients and the finished food product have been produced according to specific requirements of USDA Organic Certification such that peas would only come in contact with USDA organically approved herbicides, pesticides, process aids and cleaning materials.

Many terms can be used to describe the sensorial properties of food product embodiments of the current disclosure which were made with the insoluble pea protein product, soluble pea protein product, and combined soluble and insoluble pea protein products of the current disclosure. In this specification and claims, the term firm texture means that there is resistance when a product is first bitten into. An elastic texture herein means a product has a spring, or elasticity, when chewed. A cohesive texture herein means that when product is chewed, the product mass feels like it is holding together and not dissolving fast as chewed. A crunchy texture herein means that when a product is chewed, there is both an audio and tactile sensorial experience as the product breaks and falls apart into pieces as it is chewed. A more crunchy texture is when there is a louder audio sensorial effect and there are more pieces resulting when a product fractures during chewing (such as with a hard and brittle product). A smooth texture herein means that a fluid product flows and is smooth on the tongue without noticeable sensation of particles. A gritty texture herein means that a fluid product flows and feels rough on the tongue due to noticeable sensation of particles.

A natural ingredient to partner with pea protein is pea fiber, which is a product of the pea separation process. Pea fiber (hull and internal) has the ability to work in gluten free products by giving products additional water absorption and water maintenance that gluten usually performs in wheat based pasta products. Another added benefit of the use of the pea fiber product is its slightly toasted, nutty flavor, as well as the absence of a “pea” or “beany” flavor often present in by-products of legume manufactured materials.

Fiber has been defined to be the components of plants that resist human digestive enzymes, a definition that includes lignin and polysaccharides. These digestible enzymes cannot split the glycosidic bonds and the fiber moves through the digestive system to the large intestine. Chemically, fiber consists of non-starch polysaccharides such as cellulose, pectin, lignin and oligosaccharides.

Though all plants contain some fiber, the means by which that fiber is separated from the plant and further processed effects the functionality of the resulting fiber material. Peas contain fiber both in their hull (outer portion) and in their seed (inner portion). The pea hull fiber product used this disclosure would be defined as dietary fiber under FDA (21 CFR sect. 101.9 (c) (6) (i) as it is “intact and intrinsic”, that is, in its natural state. Pea hull fiber product would be similar to the “bran” example used by the FDA as an example of plant fiber that is “intact and intrinsic”. The pea fiber that is from the interior of the pea may also be labeled as dietary fiber according to FDA, as the pea fiber falls within the definition of “cell wall materials”, which has been shown to have medical benefits.

Dietary fibers can act by changing the nature of the contents of the gastrointestinal tract and by changing how other nutrients and chemicals are absorbed. Some types of soluble fiber absorb water to become a viscous substance that is fermented by bacteria in the digestive tract. Some types of insoluble fiber have bulking action and are not fermented. Lignin, a major dietary fiber source, may alter the rate of metabolism of soluble fibers. Other types of insoluble fiber are fully fermented. Some but not all soluble plant fibers block intestinal mucosal adherence and translocation of potentially pathogenic bacteria and may therefore modulate intestinal inflammation, an effect that has been termed caotrabiotic. Advantages of consuming fiber are the production of healthful compounds during the fermentation of soluble fiber, and insoluble fiber's ability (via its hygroscopic properties) to increase bulk, soften stool, and shorten transit time through the intestinal tract. Fiber supplements have been used by consumers for managing irritable bowel syndrome.

Another ingredient to naturally partner with pea protein is pea starch. Pea starch has many functional properties, including viscosity building, solids suspension control, and also adds bulk, as well as being an excellent energy source. Pea starch has its own unique composition in that it contains high amylose content, which allows this pea starch to be surprisingly helpful in creating many food products with ideal and preferred texture. There is also an interaction with pea protein (theoretically more interaction with the smaller, soluble, semi-linear, less-globular geometric form pea protein product than with the insoluble, larger molecular weight, globular geometric form pea protein product) and pea starch's amylose molecules. In theory, the amylose molecular chains of glucose can align and network with each other and with semi-linear, less-globular proteins to create a matrix or gel. This matrix or gel structure can trap other molecules (including water) when the conditions are advantageous.

Small oligosaccharides embodiments of the current disclosure that are produced by the pea separation process are useful to food product formulators. These oligosaccharides can be used to add bulk and thickening to food products. They can also add some sweetness, especially if the oligosaccharides have very low molecular weights. The oligosaccharides from the pea separation process can be used as food for fermentation, especially, but not necessarily, when combined with protein product of the pea separation process.

Manufacturers of consumer food products are looking for creative sources of familiar food products that meet consumers' nutritional and “clean” labeling needs. There are many sources of protein available to make food products with desired flavor and texture, but few protein products are able to meet all dietary and “clean” labeling requirements of today's consumer. Pea protein product of the current disclosure can meet all of these dietary and labeling requirements. Though a remaining challenge with the currently available pea protein products is that they are based on the globular form of pea protein, which has a PDCAAS of less than 1.0 due to limited sulfur containing amino acids. Another challenge of the currently available pea protein products is that they have good functionality, but have some limiting functionalities, especially when high protein content is desired in a food product.

Therefore there is need for a soluble pea protein product [alone and combined with insoluble pea protein product] that can be used to make food products with the consumer desired texture, taste, nutrition, and labeling requirements, as well PDCAAS value.

### SUMMARY

The disclosure below uses different embodiments to teach the broader principles with respect to compositions, articles of manufacture, apparatuses, processes for using them and apparatuses, processes for making them, and products produced by the process of making, along with necessary intermediates. This Summary is provided to introduce the idea herein that a selection of concepts is presented in a simplified form as further described below. This Summary is not intended to identify key features or essential features of subject matter, nor does this Summary intend to be used to limit the scope of claimed subject matter. Additional aspects, features, and/or advantages of examples will be indicated in part in the description which follows and, in part, will be apparent from the description, or may be learned by practice of the disclosure.

The present disclosure relates to unique pea protein products that contains soluble pea protein product that, when combined with insoluble, globular pea protein product, the resulting pea protein product has a PDCAAS of about 0.75-1.00. The soluble pea protein product can be used alone to make aerated bakery products, confections, desserts, sauces, and beverages. The soluble pea protein product can be combined with insoluble, globular pea protein product to make a range of food products with higher protein content than when only insoluble, globular pea protein product is used alone, due to the viscosity reducing nature of the soluble pea protein product when it is combined with insoluble globular pea protein product. The process to make this unique soluble pea protein includes means of selectively separating the soluble pea protein product from the insoluble fractions of ground peas, as well as selectively separating the soluble pea protein from soluble carbohydrates and ash.

### DETAILED DESCRIPTION OF DISCLOSURE

The current document discloses a unique soluble pea protein product that alone or in combination with insoluble pea protein product can create unique gluten free, and allergen free food products with consumer desired taste and texture, as well as consumer desired “clean” labels.

The disclosure uses different embodiments to teach the broader principles with respect to compositions, apparatuses, processes for using them and for making the compositions, and products produced by the process of making, along with necessary intermediates.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term Likewise, the disclosure is not limited to various embodiments given in this specification.

Without intent to limit the scope of the disclosure, examples of products and uses, equipment, processes and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

The pea protein product embodiments of the current disclosure include pea protein products that contain soluble (smaller, semi-linear, less-globular) pea protein product alone and combined soluble (semi-linear, less-globular) pea protein product and insoluble (larger, globular) pea protein products. The embodiments that include soluble (semi-linear, less-globular) pea protein product are not less than 60 dwt % pea protein. Other components of the soluble pea protein product include pea starch, fiber, and/or oligosaccharides. The embodiments that include combined soluble (semi-linear, less-globular) pea protein product and insoluble (granular) pea protein products are not less than 60 dwt % protein. Other components of the combined soluble and insoluble pea protein product include pea starch, fiber, and/or oligosaccharides. Other embodiments are food products that include the soluble pea protein product and/or the combined soluble and insoluble pea protein product. The examples given are illustrations of the use of embodiments of the pea protein products.

A pea protein product embodiment of this disclosure, comprises: a) at least about 40% dry weight pea protein; and b) at least about 90% dry weight of the pea protein is soluble at room temperature and at about pH 3-10. This pea protein product embodiment has a pH of 6-8. A pea protein product embodiment of this disclosure has at least about 60% of the protein in the pea protein product has a molecular weight less than about 100 Daltons. A pea protein product embodiment of this disclosure has a molecular weight of less than about 30, preferably less than about 20 Daltons.

A pea protein product embodiment of this disclosure has about 1-60 dwt % of the protein soluble in water; and about 99-40 dwt % of the protein insoluble in water. This pea protein product has a PDCAAS of 0.9-1.0. The pea protein product has about 10-99 dwt % of the soluble protein content has a molecular weight of less than about 50 Daltons.

A pea protein product embodiment of this disclosure comprises: about 95-5 dwt % carbohydrate; and about 5-95 dwt % protein; wherein about 1-60 dwt % of the protein is soluble in water; and about 99-40 dwt % of the protein is insoluble in water. This pea protein product embodiment, wherein about 10-99 dwt % of the soluble protein has a molecular weight of less than about 50 Daltons.

A pea protein product embodiment of this disclosure has a molecular weight of about 5 to about 40 Daltons; a solubility of greater than about 70% at pH greater than 4; and a higher sulfur containing amino acid content than insoluble pea protein with a PDCAAS of about 0.75-1.0.

An embodiment of the current disclosure is the creation of various carbohydrate products of the pea separation process, including, but not limited to fiber, starch, oligosaccharides, and combinations thereof. These carbohydrate products are used as viscosity modifiers, bulking agents, and food source for fermentation (with and without additional protein material).

The an embodiment of a process of the current disclosure is a method of manufacturing the soluble pea protein product and the combined soluble pea protein and insoluble pea protein product embodiments with physical characteristics that gives them unique functional characteristics, which makes the pea protein products useful in creating finished food products with the flavor and textural characteristics desired by consumers, while meeting consumers' labeling and dietary needs.

A key to the functionality of soluble (semi-linear, less-globular) pea protein product and combined soluble (semi-linear, less-globular) pea protein product and insoluble (globular) pea protein product is how these materials are separated from harvested hulled peas. Peas are harvested and sorted to remove foreign mater, then processed to remove the hull from the seed, and finally grind the seed to make pea flour. The process for producing the pea protein embodiments of the current disclosure has five steps: 1) creating a pea protein intermediate slurry containing at least 70% dry weight pea protein; 2) treating the pea protein intermediate slurry so as to precipitate out the insoluble (globular) pea protein product at pH 4.5-5.5; 3) treating the remainder (including raising the pH) to remove insoluble materials; 4) treating the remainder (i.e., soluble materials) to separation means to remove carbohydrates and ash materials; and finally 5) concentrating and/or drying to get the final soluble (semi-linear, less-globular) protein product.

One method to create the pea protein intermediate slurry containing at least 70% dry weight pea protein includes first mixing pea flour with water and basic (i.e., caustic) ingredients, which solubilizes all pea proteins and allows the separation of the majority of the starch from the stream containing protein. The stream is then decanted to remove a majority of the fiber, creating an at least 70% dry weight pea protein stream.

Separation Process Example:

The process of making a pea protein product embodiment of the current disclosure includes the steps of:
a) grinding de-hulled dry peas;
b) mixing the ground peas with water to make a slurry;
c) separating the insoluble fiber and starch portions from the protein portions to make an intermediate protein slurry,
d) coagulating the protein to make an insoluble protein in the intermediate protein slurry,
e) neutralizing the insoluble protein in the intermediate protein slurry,
f) optionally, intermixing the neutralized intermediate protein slurry with enzyme,
g) heating the neutralized intermediate protein slurry to
about 90-200 F for 5-120 minutes;
h) separating water from the heated neutralized intermediate protein slurry to make a finished insoluble pea protein product and a water solution;
i) filter water solution with filter sized to remove soluble carbohydrates and ash; and
j) further process protein product remaining in water solution after filtering out soluble carbohydrates and ash to create soluble pea protein product.

The process example described above, wherein an enzyme or a microorganisms is further added to the water solution before filtering out carbohydrates.

The process example described above, wherein an enzyme or a microorganism is further added to the water solution after filtering out carbohydrates.

The process example described above, wherein the water solution with an enzyme or a microorganism is further filtered to remove carbohydrates.

The process example described above uses microfiltration, ultrafiltration, centrifugation or combinations thereof to filter or separate carbohydrates, proteins, ash, or combinations thereof from the water solution.

The process example described above, wherein further processing of the pea protein remaining in the water solution includes removing at least a portion of the water.

The process example described above, wherein further processing of the pea protein remaining in the water solution includes combining it with at least a portion of the insoluble pea protein separated from the water portion.

The process example described above; further processing step is reducing the water content of the combined soluble and insoluble pea protein product.

The pea protein product embodiment of this disclosure is soluble and at least about 60% of the protein in the pea protein product has a molecular weight less than about 100 Daltons, less than about 30, and (preferably) less than about 20 Daltons.

Key to the creation of the soluble pea protein product embodiments of the current disclosure is the means of separating the various soluble materials, including small soluble carbohydrates (i.e., sugars and oligosaccharides), ash, and soluble proteins. Logic would suggest using filters for size separation (e.g., ultrafiltration or microfiltration), but commercial practicality demands an efficient separation (e.g., fast speed of separation) and filters can have a tendency to clog or just be very slow to work because of build-up on the surface of the filters.

The pea protein product of any embodiment of the current disclosure contains about 1-50 dwt % carbohydrate.

Means to make the separation more efficient include, but are not limited to, use of enzymes or microorganisms or combinations of acids and/or bases to selectively breaks down that materials that clog the filters and/or build up on the filters. These means need to be carefully selected so that the resulting soluble pea protein products maintain their useful functionality. When the clogging and/or build up material is carbohydrate based, then selective amylases can be used to chop up the carbohydrates into smaller units and increase the efficiency of separation, or selective acids can be used to chop up the carbohydrates into smaller units and increase the efficiency of separation. The choice of means of improving the rate of separation is key to the functionality of the final soluble pea protein product and the separated oligosaccharide product.

Protein PDCAAS: Protein is a key nutrient necessary for growth of muscles and general metabolism. As already mentioned, proteins can vary in amino acid content. The amino acid content is important in determining the “quality” of the protein towards human nutrition needs. According to Food and Drug Administration (“FDA”) children (under 5 years old) and adults need certain amounts of amino acids in their daily diets.

According to FDA Nutrition Labeling regulations, foods are to be labeled with the grams of protein in a serving of product. Optionally, food manufacturers may also include in the label the % Daily Value of the recommended daily intake of protein (equivalent to amino acid content and digestibility of casein). As discussed earlier in this disclosure, casein has a PDCAAS of 1.00. Protein amino acid content and its digestibility is compared to that of casein before calculating % DV.

Pea protein produced by most published methods of protein separation from whole peas, is insoluble at pH 4.5-5.5, and has a globular geometric form, and has a manufacturer's published PDCAAS value of .62-.82. This can be a problem for food product formulators who are trying to replace milk and meat based proteins (which have PDCAAS=1.0) with a pea protein product. One for one replacements of pea protein (globular) for casein protein could result in equivalent functional characteristics, but would result in lower % DV amounts on the resulting product label. This replacement with insoluble, globular pea protein products would translate into needing more grams of pea protein (globular) per serving of food product as that needed when the food product is made with a milk or meat based protein. Such extra addition or protein product could have negative economic repercussions for protein ingredient replacement.

A solution to these labeling and formulating problems was to develop a new pea protein product that has a PDCAAS similar to that of casein, and other milk and meat based proteins. The pea separation process of embodiments of this disclosure are able to create a new soluble pea_protein product with an amino acid content that can fill-in the amino acids not present in insoluble, globular pea protein product. This allows for the creation of a “complete” pea protein product (PDCAAS=1.0) that was a combination of the new pea protein (soluble, semi-linear, less-globular geometric type) product with insoluble pea protein (globular geometric type) product.

As shown in following tables, insoluble, globular pea protein has a PDCAAS less than 1.0 because of it is lower than optimum sulfur containing amino acids. The soluble pea protein product has a PDCAAS less than 1.0 because of its lower than optimum content of some amino acids, though not because of lower content of sulfur containing amino acids. Surprisingly, the amino acids short in one type of pea protein product can be made up with the amino acids in the other type of pea protein product—allowing the creation of a combined pea protein product with a complete amino acid profile allowing for the combined pea protein product to have a PDCAAS of .9 -1.00. The specific amino acid contents are identified by FDA labeling regulations.

TABLE 1
Combined Pea Protein Product with PDCAAS 1.00

| | % of Crude |
|---|---|
| Amino Acid | Protein |
| Aspartic Acid | 11.8% |
| Threonine | 4.3% |
| Serine | 4.6% |
| Glutamic Acid | 16.7% |
| Proline | 4.4% |
| Lanthionine § | 0.0% |
| Alanine | 5.1% |
| Cysteine | 1.6% |
| Valine | 5.0% |
| Methionine | 1.0% |
| Isoleucine | 4.5% |
| Leucine | 7.1% |
| Tyrosine | 3.9% |
| Phenylalanine | 4.9% |
| Hydroxylysine | 0.0% |
| Histidine | 2.7% |
| Arginine | 7.9% |
| Tryptophan | 1.1% |
| Protein Quality Ratio | 1.05 |
| PDCAAS | 1.00 |

In Table 2, * refers to an example of a soluble pea protein (Experimental) and ** refers to an example of an insoluble globular pea protein (P870 supplied by Puris). Table 2 shows the contents of a soluble pea protein product and an insoluble globular pea protein product and how their contents can be combined to make a combined pea protein product with the full FDA amino acid requirements for PDCAAS 1.00.

TABLE 2
Amino Acid Contents (Soluble and Insoluble Protein Products)
Amino Acid Profile

| | | | | | PURIS | | |
|---|---|---|---|---|---|---|---|
| | | Soluble Pea Product* | | | Soluble | Insoluble Pea Product** | |
| | | Expermental A | Tiet et. Al | Experimental B | Stream | Tiet et. Al | PURIS |
| | Taurine§ | 0.08% | | | | | |
| | Hydroxyproline | 0.10% | | | | | |
| G | Aspartic Acid | 11.75% | 11.90% | 12.10% | 11.74% | 12.99% | 11.77% |
| x | Threonine | 5.77% | 5.66% | 6.20% | 5.09% | 3.34% | 3.81% |
| x | Serine | 3.61% | 5.03% | 4.90% | 4.10% | 5.30% | 4.91% |
| G | Glutamic Acid | 17.04% | 14.95% | 16.90% | 24.36% | 18.66% | 16.62% |
| | Proline | 4.18% | 4.46% | 4.30% | 3.88% | 4.36% | 4.47% |
| | Glycine | 6.39% | 5.97% | 6.50% | 6.20% | 3.89% | 4.08% |
| | Alanine | 7.36% | 5.85% | 7.40% | 6.09% | 3.97% | 4.31% |
| x | Cysteine | 3.21% | 3.15% | 2.90% | | 0.80% | 1.08% |
| x | Valine | 3.86% | 4.41% | 4.10% | 3.88% | 4.73% | 5.32% |
| x | Methionine | 0.98% | 1.34% | 0.90% | | 0.70% | 1.04% |
| | Isoleucine | 2.71% | 3.86% | 2.90% | 2.88% | 4.59% | 5.04% |
| | Leucine | 3.02% | 4.87% | 3.60% | 3.54% | 8.23% | 8.47% |
| x | Tyrosine | 4.09% | 4.71% | 4.20% | 4.10% | 3.37% | 3.90% |
| x | Phenylalanine | 3.09% | 4.52% | 3.30% | 3.21% | 5.40% | 5.54% |
| x | Lysine | 11.03% | 9.34% | 10.20% | 9.97% | 6.41% | 7.65% |
| G | Histidine | 3.19% | 2.63% | 3.10% | 3.43% | 2.55% | 2.49% |
| G | Arginine | 6.06% | 5.67% | 6.00% | 7.53% | 8.00% | 8.51% |
| x | Tryptophan | 1.17% | 1.47% | 0.70% | | 0.67% | 1.01% |
| | Total | | | | | | |
| | Crude | | | | | | |
| | protein* | | | | | | |
| | Moisture | | | | | | |
| | Crude Fat | | | | | | |
| | (acid | | | | | | |
| | hydrolysis) | | | | | | |
| | Ash | | | | | | |

| | |
|---|---|
| W/W % = grams per 100 grams of sample. | Crude protein* = % N × 6.25. |
| | § Non-proteinogenic amino acids. |

Results are expressed on an “as is” basis unless otherwise indicated.
Tiet. Et Al is The Isolation, Modification and Evaluation of Field Pea Proteins and Their Applications in Foods, by Shaojun Tian, Victoria University of Technology, Australia 1998.

Table 3 shows the combinations of an example of a soluble and an example of an insoluble pea protein that will result in a PDCAAS of 1.00 or greater. This combination could be created by manufacturing a soluble pea protein product and manufacturing an insoluble pea protein product and then combining them at the appropriate ratios (80/20 to 70/30 insoluble globular pea protein product/soluble pea protein product) to create a complete pea protein product. A complete pea protein product could be made by first separating out the soluble pea protein product, and then slowly adding it into the insoluble globular pea protein stream, before drying either of the pea protein products.

A problem solved by the inventors of this pea protein product embodiments of the current disclosure was the means of making the processing of pea protein product more efficient. Problems with manufacturing pea protein product is the restrictions cause by the flowability of the wet insoluble globular pea protein product. The inventors found that by adding a portion of soluble pea protein product to the stream of insoluble globular pea protein (in production) before drying the insoluble globular pea protein product, more pounds of pea protein product could be dried per hour. This results in a significant increase in efficiency and thus, cost reduction. And, this also creates the combined soluble pea protein and insoluble pea protein product with PDCAAS 1.0. As discussed in another place in this disclosure, combining the soluble pea protein and the insoluble pea protein products can create an increase in total pea protein product flowability, and with such, a faster and more efficient water removal process.

TABLE 3
Amino Acid Profiles of Combinations of Insoluble
Pea Protein Product/Soluble Pea Protein Product
(Experimental) (Ratio 75/25 had PDCAAS 1.0)

| Amino Acid | Mixture | | |
|---|---|---|---|
| Profile | 80/20 | 75/25 | 70/30 |
| Taurine § | | | |
| Hydroxyproline | | | |
| Aspartic Acid | 11.8% | 11.8% | 11.8% |
| Threonine | 4.2% | 4.3% | 4.4% |
| Serine | 4.7% | 4.6% | 4.5% |
| Glutamic Acid | 16.7% | 16.7% | 16.7% |
| Proline | 4.4% | 4.4% | 4.4% |
| Glycine | 4.5% | 4.7% | 4.8% |
| Alanine | 4.9% | 5.1% | 5.2% |
| Cysteine | 1.5% | 1.6% | 1.7% |
| Valine | 5.0% | 5.0% | 4.9% |
| Methionine | 1.0% | 1.0% | 1.0% |
| Isoleucine | 4.6% | 4.5% | 4.3% |
| Leucine | 7.4% | 7.1% | 6.8% |
| Tyrosine | 3.9% | 3.9% | 4.0% |
| Phenylalanine | 5.1% | 4.9% | 4.8% |
| Lysine | 8.3% | 8.5% | 8.7% |
| Histidine | 2.6% | 2.7% | 2.7% |
| Arginine | 8.0% | 7.9% | 7.8% |
| Tryptophan | 1.0% | 1.1% | 1.1% |

Pea protein produced by most common methods of protein extraction from whole peas, is insoluble and has a globular geometric type that has the functional abilities of controlling aeration, viscosity, suspension, and solubility, but these functions are limited by the limited exposure of its amino acids to the environment the proteins are attempting to influence. Surprisingly, the inventors of this application found that by combining their invented new pea protein product (soluble, semi-linear, less-globular geometric type) with the globular (insoluble) pea protein product, they are able to increase the functionality of the combined pea protein product in many food products. That is, a synergy was found when the new pea protein product (soluble, semi-linear, less-globular geometric type) is combined with the globular (insoluble) pea protein.

### Example of Synergy (Viscosity/Flow)

A combination of new pea protein (soluble, semi-linear, less-globular geometric type) and current pea protein (insoluble, globular geometric type) at different ratios showed that there was a synergistic effect on mixture's flowability. Not to be held by any theory, the cause of this synergy can be attributed to reaching a balance between the polarity (reactivity by exposed amino acid charges groups), and so the binding ability, between the new pea protein (semi-linear, less-globular) material and the current pea protein (globular) material. A unique factor of the soluble and insoluble pea protein embodiments of the current disclosure is that they have a synergy that effects pea protein product viscosity, which can be a benefit towards processing of pea protein products.

To further understand how the addition of pea soluble to a PURIS Pea Protein 870 slurry effected the flowability of the mixture, tests were run. In the processing facility the insoluble (globular) protein product stream has an original solids content of 22-24%, but is lowered, with the addition of water, to approximately 20% solids for ease of pumping. The addition of soluble pea protein product could reduce the amount of water needed to allow the insoluble protein product to flow easier allowing for cost savings. In this research, Pea Soluble and Soluble mean soluble pea protein product. The soluble pea product used in this research was experimental. The P870 pea protein material (insoluble pea protein product) used in the research was sourced from PURIS (Minneapolis, Minn. USA).

Method: All variations were prepared based on the control (20% solids), which was used to simulate conditions found in the processing facility. Samples were prepared by first weighing the correct ratio of P870 and pea soluble to create a range in percent solids when mixed with 112.5 g of water. Next, the sample was allowed to mix for 3-5 minutes using a Kitchen Aid blender until the protein was evenly distributed. Once completely mixed, the sample was poured into a Bostwick Consistometer and the distance the mixture traveled/flowability (cm) in 30 seconds was recorded. All variations were recorded in triplicates and averages were calculated.

Next, three specific ratios of P870 and pea soluble were mixed to see the amount of water needed to reach the desired flowability shown by the control (insoluble pea protein product) of 21.47 cm.

Table 4, 5, 6, and 7 illustrate the viscosity results for combinations of globular (insoluble) pea protein (e.g., P870, Puris Proteins, MPLS, Minn.) and semi-linear, less-globular (soluble) pea protein (experimental). A further factor of the combination of insoluble, globular pea protein and soluble, semi-linear, less-globular pea protein was the ability to combine the two pea protein products to create a “complete” pea protein product, which was a pea protein product with a PDCAAS of 1.0.

TABLE 4
Flowability Results: P870 + Pea Soluble

| | Total | | | | | | |
|---|---|---|---|---|---|---|---|
| | Water | Total Protein | | P870 | Soluble | Soluble | Reading |
| Total Solids | (g) | (g) | P870 (g) | (%) | (g) | (%) | (cm) |
| 20% solids | 112.5 | 28.20 | 28.20 | 100.00 | 0.00 | 0.00 | 21.47 |
| 23% solids | 112.5 | 33.60 | 33.60 | 100.00 | 0.00 | 0.00 | 1.00 |
| 23.5% solids | 112.5 | 34.60 | 33.60 | 97.10 | 1.00 | 2.89 | 2.50 |
| 24% solids | 112.5 | 35.60 | 33.60 | 94.38 | 2.00 | 5.60 | 1.35 |
| 24.5% solids | 112.5 | 36.60 | 33.60 | 91.80 | 3.00 | 8.19 | 5.00 |
| 25% solids | 112.5 | 37.60 | 33.60 | 89.36 | 4.00 | 10.64 | 4.03 |
| 25.5% solids | 112.5 | 38.60 | 33.60 | 87.00 | 5.00 | 12.95 | 7.70 |
| 26% solids | 112.5 | 39.60 | 33.60 | 84.84 | 6.00 | 15.15 | 7.13 |
| 28% solids | 112.5 | 43.60 | 33.60 | 77.06 | 10.00 | 22.93 | 15.57 |
| 30% solids | 112.5 | 47.60 | 33.60 | 70.79 | 14.00 | 29.41 | 17.23 |

TABLE 5
Flowability (cm) of Protein Mixture
for Varying P870 + Pea Soluble Ratios

| Total Solids(%) | Flowability (cm) |
|---|---|
| 20 | 21.47 |
| 23 | 1.00 |
| 23.5 | 2.50 |
| 24 | 1.35 |
| 24.5 | 5.00 |
| 25 | 4.03 |
| 25.5 | 7.70 |
| 26 | 7.13 |
| 28 | 15.57 |
| 30 | 17.23 |

In Tables 4 and 5, flowability can be seen as the percentage of pea soluble increased. Although none of the ratios met the control, a trend can be seen. As the percentage of pea soluble increased in the protein mixture so did the flowability of the product. This is promising and shows that additions of soluble pea protein product (especially at additions of 20-30%) can at least partially replace water during processing while having a significantly higher percent solids, which theoretically would improve plant processing efficiency. Other points to consider include that 20-30% pea soluble additions can improve the protein quality of P870 by making it a complete, or near complete, protein.

Table 6 shows the amount of water needed at specific P870 +pea soluble percentages to have a flowability similar to that of the control. The data shows that the higher the percentage of pea soluble used, the less amount of water addition needed. When comparing pea soluble added at 22.93% versus 2.89% there was a 12.5 g difference in the amount of water needed to be added to have a mixture similar to the control.

TABLE 6
Flowability (cm) of Three Specific P870 + Pea Soluble
Ratios to See the Amount of Water Needed to have a Similar
Flowability as the ControlP870 + Pea Soluble

| | | |
|---|---|---|
| Total Solids (%) | Water Added (g) | Flowability (cm) |

P870 (77.06%) + Pea Soluble (22.93%)

| | | |
|---|---|---|
| 30.4 | 100 | 0 |
| 28.4 | 110 | 10.5 |
| 27.5 | 115 | 16 |
| 26.7 | 120 | 19.2 |
| 26.2 | 122.5 | 21.3 |

P870 (89.36%) + Soluble (10.64%)

| | | |
|---|---|---|
| 25.5 | 110 | 1 |
| 23.9 | 120 | 8.2 |
| 23.5 | 122.5 | 17.4 |
| 23.1 | 125 | 20.3 |

P870 (97.1%) + Soluble (2.89%)

| | | |
|---|---|---|
| 23.9 | 110 | 0 |
| 22.4 | 120 | 6 |
| 21.0 | 130 | 17.7 |
| 20.7 | 132.5 | 22.4 |
| 20.4 | 135 | 23.4 |

A combination of soluble pea protein (semi-linear, less-globular) and insoluble pea protein (globular) at different ratios was shown to have synergy. There were synergistic combinations of the two protein products that created improvements in physiochemical functions in various food products. Not to be limited by theory, the cause of this synergy can be attributed to each pea protein product having a physical form/type, an amino acid content, and exposure or protection of those amino acids that contributed to the total physicochemical functionality of the combined protein products in food products. The combination of the two pea protein products created greater aeration and viscosity because of the combined interactions of the available (i.e., exposed) charged reactivity points and non-polar points of each of the protein products.

The limits to the functionalities of the soluble (semi-linear, less-globular) pea protein product and of the insoluble (globular) pea protein product are based on their amino acid groups and their geometries that expose charged or non-charged (non-polar) surfaces to the fluids and solids present in the environment surrounding them. Not to be limited by any theory, the roughly semi-linear, less-globular geometry of the new soluble pea protein product creates many charged (polar) surface areas and few non-charged (nonpolar) surface areas. Not to be limited by any theory, the roughly globular geometry of the current insoluble pea protein product creates some charged (polar) surface areas and many non-charged (nonpolar) surface areas. It appears from the results of the use of both soluble and insoluble pea protein products together in various food products, that there is a certain maximum functionality created when certain combinations of both the soluble and the insoluble pea protein products are used together. The use ratio of these two pea protein products can vary depending on the functionality wanted/needed in a particular food product. For example, more aeration control functional abilities in bakery products could require a different ratio of new soluble pea protein (semi-linear, less-globular) to current insoluble pea protein (globular) than more particle suspension control functional abilities in dry beverage mixes.

### Functionality of Soluble Pea Protein in Food Product

The unique pea protein products (that is, soluble pea protein embodiments and combined soluble and insoluble pea protein product embodiments of this disclosure) can be used in many food products to create product improvements in density, aeration, viscosity, cohesion, thickness, toothpak, chewiness, smoothness, and other food product characteristics. The soluble pea protein product embodiments of this disclosure (alone or with insoluble (globular) protein products) can serve as allergy friendly bulking agents, suspension stabilizers, aeration agents, and viscosity control agents. The soluble pea protein product embodiments of this disclosure can serve as the above texturing agents, while increasing the protein content of the food product, and when partnered with insoluble (globular) pea protein product, can also deliver higher pea quality (as evidenced by PDCAAS of 0.75 0 1.0).

Embodiments of this disclosure are food products that contain the pea protein product embodiment that includes soluble pea protein product and insoluble pea protein product, wherein the food products do not contain any animal, egg, gelatin, milk, wheat, or soybean based materials. Preferably these food products also do not include any hydrocolloids, surfactants, or gums.

Embodiments of this disclosure are food products, wherein the food products are selected from the group including milks, sports drinks, nutritional beverages, fruit based beverages, carbonated beverages, non-carbonated beverages, non-dairy beverages, acidified hot-fill beverages, Ready-To-Drink beverages, retorted beverages, aseptic packed beverages, gravies, sweet and sour sauces, fermented base sauces (e.g., oyster sauce, soy sauce, teriyaki sauces), broths, tomato based sauces, soups, white sauces, bakery products, meat analogs, cheese analogs, non-dairy products,

Embodiments of this disclosure are food products that contain the soluble pea protein product embodiments of this disclosure, wherein the food products are selected from the group including milks, sports drinks, nutritional beverages, fruit based beverages, carbonated beverages, non-carbonated beverages, non-dairy beverages, acidified hot-fill beverages, Ready-To-Drink beverages, retorted beverages, aseptic packed beverages, gravies, sweet and sour sauces, fermented base sauces (e.g., oyster sauce, soy sauce, teriyaki sauces), broths, tomato based sauces, soups, white sauces, bakery products, meat analogs, cheese analogs, non-dairy products,

Embodiments of this disclosure are pea protein products that comprise at least about 40% dry weight pea protein, at least about 90% dry weight of the pea protein is soluble at room temperature at about pH 3-10, and about 0.5-50% dry weight carbohydrate. Embodiments of this disclosure are pea protein products that further have at least 60% of the protein with a molecular weight less than 100 Daltons, preferably less than about 30 Daltons, most preferably less than 20 Daltons. This pea protein product embodiment is able to be used to stabilize a food product against air separation, foam separation, water separation, and protein coagulation during heated, ambient, refrigerated and frozen constant and cycling conditions.

Embodiments of this disclosure are pea protein products that comprise at least about 40% dry weight pea protein, at least about 90% dry weight of the pea protein is soluble at room temperature at about pH 3-10, and about 0.5-50% dry weight carbohydrate; wherein this soluble pea protein product is used at about 1 dwt % to 99 dwt % protein content in food product to create aeration, cohesion, viscosity, body, solids suspension in meat analogs, cheese analogs, non-dairy yogurts, non-dairy cheeses, non-dairy fermented products, bakery, mousse, confection, coffee topping, ice cream, frozen desert products or combinations thereof.

The soluble pea protein product of embodiments of the current disclosure can serve as an allergy friendly alternative to eggs, and sometimes butter, in bakery applications theoretically due to the pea protein product embodiment's surfactant-like properties with areas of polarity (charge) and areas of non-polarity (un-charged).

Because of the solubility of the soluble pea protein product which are embodiments of the current disclosure, this soluble pea protein product can be used in food products at higher content levels. With the synergy that occurs between soluble pea protein embodiments of the current disclosure with insoluble pea protein (e.g., that in P870), there is a unique high quality of protein possible without an increase in finished product viscosity (See earlier data).

Overall, in replacing eggs in bakery applications, the preferred percentage of soluble pea protein product embodiments of the current disclosure in a formula is 5 +/−8%. According to some food product formulation work completed by the inventors of this disclosure, at this level, the soluble pea protein product was able to provide ideal air cell formation (i.e., foaming) properties. This was been shown in waffles, cookies, brownies, and cake examples. Higher amounts of soluble pea protein product had lead (in these limited and specific recipes) to the collapse of the air cells of the food products, which contained high levels of soluble pea protein product. Theoretically, this collapse was caused by an unmet need in moisture availability (i.e., moisture competition among ingredients). High levels of soluble pea protein product was found to be preferred in food product applications where a caramel like texture was desired, such as in a fudgy brownie. This result of adding high levels of soluble pea protein product would also be useful in the creation of chewy products, such as, but not limited to caramels, toffees, chewy candy (while allowing a high protein content).

### Examples: Use of Soluble Pea Protein Product alone and Combined Soluble and Insoluble Pea Protein Product.

The added functionality of soluble pea protein product and combined soluble and insoluble pea protein product was found useful in the creation of new, more ideal textured, gluten free bakery products. In a broad sense, the soluble pea protein was used as a substitute for eggs and egg whites, which are the traditional means of incorporating air into food products. When both soluble and insoluble pea protein product is incorporated into a food product, more protein can be added (i.e., higher % protein content) and the %DV can be increased because of the complete protein nature of the combined pea protein product of the current disclosure. Also, because these pea protein products have minimal flavor (unlike soybean based proteins), consumers will be able to get the flavor and texture expected from food products made with traditional protein ingredients.

The soluble pea protein material used in this research was experimental. The P870 pea protein material and P870MV pea protein material (both insoluble globular pea protein products) used in the research was sourced from PURIS (Minneapolis, Minn. USA). The PURIS™ Gluten Free Flour and the PURIS™Gluten Free Cake Blend used in following examples had the following nutrition and ingredients (PURIS, MPLS, Minn.).

Brownies

TABLE 9
Brownie Example Formulations

| Ingredient | BV1 (g) | BV2 (g) | BV3 (g) | BV4 (g) | BV5 (g) | BV6 (g) | BV7 (g) | BV8 (g) | BV9 (g) |
|---|---|---|---|---|---|---|---|---|---|
| PURIS ™ | 113 | 113 | 113 | 113 | 113 | 113 | 113 | 113 | 113 |
| Gluten Free | | | | | | | | | |
| Flour | | | | | | | | | |
| Enjoy | 170 | 170 | 170 | 170 | 170 | 170 | 170 | 170 | 170 |
| Life ® Semi | | | | | | | | | |
| Sweet | | | | | | | | | |
| Chocolate | | | | | | | | | |
| Chips | | | | | | | | | |
| Barry | 64 | 64 | 64 | 64 | 64 | 64 | 64 | 64 | 64 |
| Callebaut | | | | | | | | | |
| Cocoa | | | | | | | | | |
| Processed | | | | | | | | | |
| with Alkali | | | | | | | | | |
| Butter, | 113 | 113 | 113 | 113 | 113 | 113 | 113 | 113 | 113 |
| unsalted | | | | | | | | | |
| Eggs | 50 | 50 | 50 | 0 | 0 | 0 | 0 | 0 | 0 |
| Sugar | 298 | 298 | 298 | 298 | 298 | 298 | 298 | 298 | 298 |
| Salt | 3 | 3 | 3 | 3 | 3 | 3 | 3 | 3 | 3 |
| Baking | 4.5 | 4.5 | 4.5 | 4.5 | 4.5 | 4.5 | 4.5 | 4.5 | 4.5 |
| Powder | | | | | | | | | |
| Vanilla | 4.2 | 4.2 | 4.2 | 4.2 | 4.2 | 4.2 | 4.2 | 4.2 | 4.2 |
| Extract, | | | | | | | | | |
| McCormick | | | | | | | | | |
| Soluble Pea | 50 | 50 | 25 | 75 | 75 | 50 | 15 | 40 | 0 |
| Protein* | | | | | | | | | |
| Water | 50 | 75 | 25 | 125 | 85 | 70 | 115 | 110 | 100 |
| PURIS ™ | 0 | 0 | 0 | 0 | 0 | 0 | 0 | 0 | 50 |
| Pea Protein** | | | | | | | | | |

*Soluble Pea Protein Product, Experimental
**P870, Insoluble Pea Protein Product, PURIS, Minneapolis, MN

Objective: To determine the effectiveness of using insoluble pea protein product or soluble pea protein product (embodiments of the current disclosure) in egg replacement in brownies.

Method: Control brownie was prepared according to the standard recipe instructions. Eggs, butter and sugar were whipped together on speed 8 in a Kitchen Aid Professional 6000 HD 6 qt mixer. Remaining ingredients were mixed in at speed 2. For trial recipes; soluble, water, sugar and baking powder were whipped on speed 8 in a Kitchen Aid Professional 6000 HD 6 qt mixer for 3 minutes. Butter was added and mixed for an additional minute. Remaining ingredients were mixed in at speed 2. Batter was spread into 9″ round baking pan that was sprayed with non-stick cooking spray and a parchment liner was placed on the bottom. Brownie was baked for 38 minutes at 350° F. Pan was removed from oven and allowed to cool for 15 minutes prior to being removed and placed on a drying rack. The center and edge heights of the brownie were measured after the brownie was completely cooled. A slice of brownie was cut to analyze the structure and stability of the brownie.

Results: Control brownie was made utilizing a standard gluten free brownie recipe that included the use of 3 whole eggs. The control brownie was a dense, rich fudgy brownie what experiences minimal collapse after baking.

Trial BV1 replaced 2 of the 3 eggs with a combination of 50 grams of soluble and 50 grams of soluble. The total combination of 100 grams replaced the weight of the eggs and displayed a similar consistency to that which 2 whisked eggs would be. Resulting batter was extremely thick and difficult to work with. Batter was extremely sticky and difficult to spread. Resulting brownie appeared slightly lighter than the control brownie and had a collapsed center. Edges of the brownie were the same height as the control brownie, however the center of the brownie was 0.5 mm less than the control brownies. The brownie was sticky and resulted in major toothpak. (Toothpak is compaction between teeth as product is chewed.) In an informal tasting panel, the taste and texture of this brownie was preferred over the control brownie.

Trial BV2 also replaced 2 of the 3 eggs but had an additional 25 grams of water added. This additional water was an attempt to make the batter easier to work with and less sticky. This addition of water resulted in a stickier batter and a more gooey brownie. BV2 was ruled to be regressive and formulation was scratched.

Trial BV3 was an attempt at replacing all 3 eggs with a combination of 75 grams of soluble pea protein product and 100 grams of water. Resulting batter was nearly too thick to work with. Upon placing the batter in the prepared pan, it was difficult to spread the batter evenly. Resulting batter ended up being in a large mass in the center of the pan. As batter was heated within the oven, it naturally spread out. After the brownie was in the oven for 38 minutes it was observed. The experimental brownie had risen to nearly above the pan. Upon removal of the pan from the oven, the brownie collapsed. Center of the brownie appeared cooked. The toothpick that was stuck into the center of the brownie revealed that the bottom of the brownie was liquid. The edges of the brownie were the consistency of caramel. Brownie was put back in the oven for an additional 15 minutes. The resulting brownie had caramelized sides that were extremely hard and a center that was still sticky. Not to be limited by theory, it appeared that the soluble pea protein product had extreme water bonding and did not release the water during baking.

Trial BV4 was a combination of 75 grams of soluble pea protein product and 125 grams of water. This version was created to verify the theory above (BV3). BV4 resulted in a brownie similar to BV3, but with even more caramelization. BV4 was left in the oven for 60 minutes with no improvement in texture.

The Trial BV5 trial was also completed to verify the above theory (water bonding). The same amount of soluble pea protein product was utilized in the BV5, but with less water than versions BV3 and BV4. The batter was also extremely sticky and difficult to work with. The batter spread itself out in the oven. The resulting brownie was closer to the control recipe than previous versions. The BV5 brownie had a crisp top layer and a chewy middle and bottom layer. The brownie did collapse in the center down to 1 mm. Not to be limited by theory, decreasing the amount of soluble pea protein product would decrease the amount of water binding.

Trial BV6 consisted of replacing 50 grams of soluble pea protein product and 70 grams of water. The resulting brownie did not collapse nearly as much as the BV5 brownie. The BV6 brownie had collapsed by 1 mm versus 2 mm of BV5. This data suggests that lower amounts of soluble pea protein product can be utilized to mimic eggs utilized in baking recipes.

The % ratio of egg to soluble pea protein in recipes was not equal. The control recipe was comprised of 16.31% eggs whereas BV6 was comprised of 5.65% soluble pea protein product with 7.91% water for a combined total of 13.55%. BV7 matched the % ratio of eggs and % ratio of soluble pea protein product and water.

Cake

TABLE 10
Cake Example Formulations

| Ingredient | Original | CV1 | CV2 | CV3 | CV4 | CV5 | CV6 | CV7 | CV8 |
|---|---|---|---|---|---|---|---|---|---|
| Gluten Free | 128 | 128 | 192 | 256 | 256 | 256 | 256 | 0 | 0 |
| Cake Flour | | | | | | | | | |
| Sugar | 227 | 227 | 156 | 340.5 | 340.5 | 340.5 | 340.5 | 5 | 25 |
| Egg Whites | 30 | 0 | 0 | 0 | 0 | 0 | 0 | 0 | 0 |
| Soluble Pea | 0 | 200 | 200 | 40 | 40 | 40 | 40 | 5 | 25 |
| Protein* | | | | | | | | | |
| Water | 0 | 225 | 225 | 100 | 100 | 100 | 100 | 50 | 250 |
| Vanilla Extract | 4.2 | 4.2 | 4.2 | 8.4 | 8.4 | 8.4 | 8.4 | 0 | 0 |
| Cream of Tartar | 5.07 | 5.07 | 0 | 0 | 0 | 0 | 0 | .6 | 3 |
| Apple Cider | 0 | 0 | 5 | 0 | 0 | 0 | 0 | 0 | 0 |
| Vinegar | | | | | | | | | |
| Baking Soda | 0 | 0 | 5.07 | 0 | 0 | 0 | 0 | .3 | 1.5 |
| Baking Powder | 0 | 0 | 5.07 | 10.14 | 10.14 | 10.14 | 10.14 | 0 | 0 |
| Oil | 0 | 0 | 28.3 | 0 | 0 | 0 | 0 | 0 | 0 |
| Milk | 0 | 0 | 0 | 165 | 165 | 165 | 165 | 0 | 0 |
| Butter | 0 | 0 | 0 | 113 | 113 | 113 | 113 | 0 | 0 |
| Salt | 0 | 0 | 0 | 1.42 | 1.42 | 1.42 | 1.42 | .2 | 1 |
| Pea Starch | 0 | 0 | 0 | 0 | 0 | 0 | 0 | 15 | 75 |
| Cocoa | 0 | 0 | 0 | 0 | 0 | 0 | 0 | 7 | 35 |
| Vanilla Flavor | 0 | 0 | 0 | 0 | 0 | 0 | 0 | .2 | 1 |
| Chocolate Chips | 0 | 0 | 0 | 0 | 0 | 0 | 0 | 5 | 25 |
| Xanthan Gum | 0 | 0 | 0 | 0 | 0 | 0 | 0 | .2 | 1 |
| Monk Fruit | 0 | 0 | 0 | 0 | 0 | 0 | 0 | .2 | 1 |
| Extract | | | | | | | | | |
| Pea Protein | 0 | 0 | 0 | 0 | 0 | 0 | 0 | 12 | 60 |
| MV** | | | | | | | | | |
| Stevia Extract | 0 | 0 | 0 | 0 | 0 | 0 | 0 | .2 | 1 |

*Soluble Pea Protein Product, Experimental
**P870, Insoluble Pea Protein Product, PURIS, Minneapolis, MN

Objective: To determine the effectiveness of replacing eggs with insoluble pea protein or soluble pea protein in cake.

Method CV1: Oven was preheated to 325° F. and 10″ round pan was lightly greased and lined with parchment paper. Flour and 3/4 cup of sugar were dry blended and set aside. 200 g of soluble was placed with 225 g of water in a Kitchen Aid Professional 6000 HD Mixer and whipped on speed 8 for five minutes. The remaining sugar, salt, and vanilla extract was added to the mixer and whipped for an additional two minutes. Flour and sugar mixture was gently folded into mixture. Batter was spooned into the pan and baked for 40-45 minutes.

Results: Trial CV1 Cake rose to the rim of the cake pan while in the oven and appeared to have a nice golden top. Upon being removed from the oven the cake collapsed. Further inspection of the cake revealed a caramel like substance below a crispy top layer.

Method CV2: Oven was preheated to 325° F. and 10″ round pan was lightly greased and dusted with flour. Flour, baking soda and baking powder were dry blended and set aside. Soluble, water, and vinegar were whipped together in a Kitchen Aid Professional 6000 HD Mixer at speed 6. The speed of the mixer was increased to 8 when the mixture became frothy. Sugar was gradually added to the mixture until incorporated. Vanilla was added and gently mixed in. Flour mixture was gently folded into the mixture. Batter was spooned into pan. Cake was baked for 25-30 minutes before being removed and allowed to cool for 5 minutes on a wire rack.

Results: Trial CV2 Cake rose to the rim and had a very golden top. The cake then collapsed upon being removed from the oven. The bottom of the cake remained gummy and sticky. The cake had no air structure upon collapsing and was very difficult to remove from pan. The bottom layer appeared to have caramelized.

Method Trials CV3, CV4, CV5: Oven was preheated to 350° F. Butter and sugar was mixed together in a Kitchen Aid Professional 6000 HD Mixer until light and fluffy. Flour, baking powder and salt were dry blended and set aside. Soluble pea protein product, water, milk and vanilla extract were combined. ⅓ of the flour mixture was incorporated into the butter mixture before adding ½ of the milk mixture. This process was repeated until all flour mixture had been utilized. Batter was then poured into two greased and lined pans. CV3 Cake was baked for 25-30 minutes. CV3 Cake was removed from the oven and allowed to rest for five minutes before being removed from the pan. This recipe was repeated but CV4 cake was allowed to bake for 42 minutes at 325° F. Trial CV5 The second iteration was repeated, but withheld the added water for CV5.

Results: The CV3 cake structure was the closest to resembling the original (control) cake structure. The edge of the CV3 cake had a dense structure but was not as gummy as the center of the cake which collapsed resembled a bread pudding. The outside cake structure had a very dense crumb structure, unlike a typical cake structure which is typically fine. The CV4 cake had minimal gumminess but stuck to the parchment paper when it was removed. TheCV4 cake did collapse slightly upon removal but maintained most of its structure. The CV5 cake resulted in a gummy cake with no internal cell structure.

Method CV6, CV7 and CV8: CV6 utilized the CV4 cake recipe to make a microwave mug cake. Batter was mixed as with CV4. Then 100 g of batter was placed in a microwave safe mug and microwaved for one minute and fifteen seconds. The batter of recipe CV7 cake was mixed as with CV4. Then 100 g of batter was placed in a microwave safe mug and microwaved for one minute and fifteen seconds

Results: The CV6 batter bubbled and rose but collapsed immediately after the microwave shut off. The resulting cooled mixture was a hard mass coating the inside of the mug. The CV7 mug cake recipe contained no butter and 5 grams of soluble pea protein product. This mug CV7 cake resulted in a mug cake that resembled an actual cake baked with eggs. The mug CV7 cake was light and fluffy with medium sized air pockets. The cake sprung back when touched and had a nice mouthfeel. Unexpectedly, the elimination of butter to the CV7 formula created an improved finished product. Not to be limited by theory, the addition of butter inhibited the soluble pea protein product from forming a stable aerated microwaveable structure.

These cake recipes were designed to duplicate a traditional wheat flour and egg cake batter recipes, though trail cake results showed unique and surprising results. Several of the trial formulas would be good models for bakery or bakery-like products with chewy characteristics or crunchy coating/surface characteristics.

Chocolate Chip Cookies

TABLE 11
Chocolate Chip Cookie Example Formulas

| Ingredient | Control (g) | CCV1 (g) | CCV2 (g) | CCV3 (g) | CCV4 (g) | CCV5 (g) |
|---|---|---|---|---|---|---|
| Butter | 227 | 227 | 227 | 227 | 227 | 227 |
| Brown | 213 | 213 | 213 | 213 | 213 | 213 |
| Sugar | | | | | | |
| Sugar | 99 | 99 | 99 | 99 | 99 | 99 |
| PURIS ™ | 290 | 290 | 290 | 290 | 290 | 290 |
| Gluten Free | | | | | | |
| Flour | | | | | | |
| Eggs | 100 | 75 | 75 | 0 | 50 | 0 |
| Vanilla | 4.2 | 4.2 | 4.2 | 4.2 | 4.2 | 4.2 |
| Extract | | | | | | |
| Xanthan | 7.24 | 7.24 | 7.24 | 7.24 | 7.24 | 7.24 |
| Baking | 3 | 3 | 3 | 3 | 3 | 3 |
| Powder | | | | | | |
| Salt | 6 | 6 | 6 | 6 | 6 | 6 |
| Baking | 4.5 | 4.5 | 4.5 | 4.5 | 4.5 | 4.5 |
| Soda | | | | | | |
| Chocolate | 340 | 340 | 340 | 340 | 340 | 340 |
| Chips | | | | | | |
| Soluble Pea | 0 | 25 | 12.5 | 50 | 25 | 0 |
| Protein* | | | | | | |
| Water | 0 | 25 | 12.5 | 50 | 25 | 100 |
| Pea Protein | 0 | 0 | 0 | 0 | 0 | 50 |
| P870** | | | | | | |

**Soluble Pea Protein Product, Experimental
**P870, Insoluble Pea Protein Product, PURIS, Minneapolis, MN

Objective: To determine the effectiveness of replacing the eggs in chocolate chip cookies with insoluble pea protein (globular) product or soluble pea protein product.

Method: Oven was preheated to 350° F. For the control chocolate chip cookies, eggs and butter were whipped together on speed 4 using a Kitchen Aid Professional 6000 HD 6 qt mixer for one minute. Remaining ingredients were slowly added. For trial recipes, soluble pea protein product and water were beat together on speed 6 for 2 minutes. Egg and/or butter were then whipped in for an additional minute before remaining ingredients were added in slowly. All cookies were then scooped in tablespoon size balls onto a parchment lined baking sheet. Cookies were baked for 11 minutes before being removed from the oven and allowed to rest on pan for 5 minutes before being moved to complete cooling on a cookie rack. Cookie spread was measured and averaged. An informal sensory panel was conducted with untrained panelists on the crunchiness, chewiness, chocolate flavor intensity, off flavor notes, odor, and overall preference.

Results: The control cookie recipe was a standard gluten free chocolate chip cookie recipe. Control cookies were soft and chewy with minimal off flavor notes.

Trial CCV1 replaced ¼ (25 g) of the normal egg amount (100 g) with a combination of soluble pea protein product and water. The soluble pea protein product replacement had an equal weight (25 g) to the amount of egg replaced (25 g) with an equal amount of water (25 g).

Trial CCV2 also replaced ¼ of the normal egg, but with a total combination (25g) of soluble pea protein product (12.5 g) and water (12.5 g) weight. CCV1 produced a cookie that was darker than the control cookie and spread 0.5 cm more than the control cookie. The CCV2 cookie was identical in color to the CCV1 cookie and had similar spread, despite the extra water.

Trial CCV3 recipe was determined based on results from CCV1 and CCV2. CCV1 was closer in spread compared to the control, but CCV2 was closer to desired texture. Therefore further formulation variations followed CCV2′s formulation by splitting the weight required to match the egg replacement between the soluble pea protein product and water. CCV3 cookies spread just as much as CCV2, at 5.5 mm. CCV3 cookies were lighter in color than CCV1 and CCV2.

Trial CCV4 formulation included eggs, soluble pea protein product and water. CCV4 cookies had full soluble spread, most at 6 mm. Not to be limited by theory, decreasing the amount of water to soluble pea protein product ratio decreased the amount of cookie spread

Utilizing insoluble pea protein (globular) product in the same way that soluble pea protein product was used created a very different dough and cookie. In following the same method and recipe as CCV3 but with insoluble pea protein product instead of soluble pea protein product, the dough required an additional 100 grams of water in order to form an appropriate mass. Once baked, the cookies failed to spread and remained in the same shape as the scoop utilized. Soluble pea protein product was an improvement upon insoluble pea protein (globular) product in regards to egg replacement.

French Macaroons

TABLE 12
French Macaroon Example Formulas

| Ingredient | MV1 (g) | MV2(g) | MV3(g) |
|---|---|---|---|
| PURIS ™ Gluten | 150 | 150 | 150 |
| Free Cake Flour | | | |
| Powdered Sugar | 218.75 | 130 | 130 |
| Salt | 1.05 | 5 | 5 |
| Soluble Pea | 50 | 125 | 125 |
| Protein* | | | |
| Water | 70 | 125 | 225 |
| Sugar | 100 | 110 | 110 |
| Vanilla Extract | 4.2 | 0 | 0 |
| Cream of Tartar | 0 | 0 | 0 |
| Pea Protein P870** | 0 | 0 | 125 |

*Soluble Pea Protein Product, Experimental
**P870, Insoluble Pea Protein Product, PURIS, Minneapolis, MN

Objective: To determine the foaming capabilities of soluble pea protein product and insoluble (globular) pea protein product in French macaroons (cookies).

Method: For MV1 cookies, flour and confectioner's sugar were mixed together. Soluble pea protein product and water were whipped for two minutes. Sugar and vanilla extract were beat into the soluble pea protein product mixture for four minutes. Flour mixture was gently folded into the soluble pea protein product mixture to preserve air structure. Mixture was transferred to a pastry bag. One inch rounds were piped one inch apart on a parchment lined sheet. Macaroons were allowed to dry for 30 minutes. Oven was preheated to 350° F. Macaroons were baked for fourteen minutes. Cookies were cooled on wire rack. For MV2 and MV3 cookies, flour and confectioner's sugar and flour were mixed together. Soluble pea protein product and water were whipped for two minutes. Cream of tartar was added and whipped for another minute. Sugar was slowly added to soluble pea protein product mixture. Flour mixture was gently folded into soluble pea protein product mixture. Mixture was transferred to a piping bag. One inch rounds were piped one inch apart on a parchment lined baking sheet. Macaroons were allowed to rest for two hours before being baked at 250° F. for 30 minutes. Cookies were cooled on wire rack.

Results: MV1 cookies had perfect glassy tops that were perfectly hardened and shaped. The bottoms spread out past the tops and were extremely hard on the outside and gooey on the inside. If the tops were pressed, they would shatter like an egg shell. The middle was hollow with a bottom that resembled caramel. MV2 cookies did not have the nice glassy top of the MV1 cookies and spread out much more. The bottoms of the MV2 cookies were similar to the MV1 cookies in the fact that they were hard on the edges and undone on the inside. MV3 cookies utilized insoluble pea protein product instead of soluble pea protein product. MV3, required an additional 100 g of water in order to form a pipeable material. These results illustrate a unique functional character of the soluble pea protein product not seen with insoluble (globular) pea protein product: an ability to create a chewy caramel like texture and an ability to create a crunchy, hard surface.

Waffles

TABLE 13
Waffle Formulations

| Ingredients | WV1 | WV2 |
|---|---|---|
| Milk | 454 | 454 |
| PURIS ™ Gluten Free Flour | 290 | 290 |
| Sugar | 25 | 25 |
| Xanthan Gum | 5.43 | 5.43 |
| Salt | 4.5 | 4.5 |
| Baking Powder | 4.5 | 4.5 |
| Soluble Pea Protein* | 5 | 0 |
| Water | 353.8 | 353.8 |
| Pea Protein P870** | 0 | 5 |

*Soluble Pea Protein Product, Experimental
**P870, Insoluble Pea Protein Product, PURIS, Minneapolis, MN

Objective: To determine the effectiveness of utilizing insoluble (globular) pea protein product or soluble pea protein product for foaming and structure in egg free waffles.

Method: Mixed all dry ingredients together and then whisked in water. Preheated waffle iron and sprayed with nonstick cooking spray. Scooped approximately ¾ cup batter into waffle iron and closed lid. Cooked waffle according to waffle iron manufacturer's instructions.

Results: Standard waffle recipe created a light and fluffy waffle but it wasn't crisp. Standard waffle recipe with added fiber was just as airy as the original recipe, but had a crisp outside. The first WV1 waffle was extremely light in color. The second WV1 waffle had more typical browning. Added crispness to the waffle was an improvement to the standard recipe. WV2 Waffles did not expand and had no structure. Batter was also much thicker and difficult to work with.

Retort Stability—Beverages/Soups

TABLE 14
Retort Stability Testing Formulations

| Ingredients | RV1 | RV2 |
|---|---|---|
| Soluble Pea Protein* | 20 | 0 |
| Water | 180 | 180 |
| Pea Protein P870** | 0 | 20 |

*Soluble Pea Protein Product, Experimental
**P870, Insoluble Pea Protein Product, PURIS, Minneapolis, MN

Objective: To determine the retort stability of insoluble (globular) pea protein product and soluble pea protein product.

Method: RV1 retorted 20 grams of soluble pea protein product with 180 g water at high pressure for 20 minutes with natural release. RV2 retorted 20 grams of insoluble pea protein product with 180 g water at high pressure for 20 minutes with natural release. Retorting process (pressure cooking) was done on a stove top pressure cooker run according to manufacturer's directions.

Results: Soluble pea protein product precipitated out under the retort conditions. Insoluble protein product formed a gel-like structure under the retort conditions.

Ice Cream

TABLE 15
Ice Cream Example Formulations

| Ingredients | IV1 | IV2 | IV3 |
|---|---|---|---|
| Milk | 735 | 0 | 0 |
| Sugar | 150 | 275 | 275 |
| Vanilla Flavor | .5 | 0 | 0 |
| Soluble Pea Protein* | 20 | 100 | 0 |
| Pea Protein P870** | 0 | 137.5 | 237.5 |
| Coconut Oil | 0 | 187.5 | 187.5 |
| Sunflower Oil | 0 | 62.5 | 62.5 |
| Pea Starch | 0 | 8.78 | 8.78 |
| Flavor Masking | 0 | .75 | .75 |
| Agent-Prova | | | |
| Toffee Flavor-Prova | 0 | .5 | .5 |
| Salt | 0 | 2.5 | 2.5 |
| Water | 0 | 1819.5 | 1819.5 |

*Soluble Pea Protein Product, Experimental
**P870, Insoluble Pea Protein Product, PURIS, Minneapolis, MN

Objective: To determine the ability of insoluble (globular) pea protein product or soluble pea protein product to increase the protein content in ice cream without compromising ice cream mouthfeel.

Method: Ingredients were blended in a Blendtech Blender on speed 1 for one minute. Slurry was heated in a sauce pan on medium high heat until slightly simmering. Mixture was then chilled for one hour in the freezer at −8° F. in a Turbo Air Deluxe Freezer. Mixture was placed in Cuisinart 2 qt Ice Cream and Frozen Yogurt maker and followed manufacture instructions.

Results: Trial IV1 formed an ice cream that was smooth upon immediate removal from ice cream maker, but then formed ice crystals upon freezing. Ice crystal formation was likely due to the addition of water to the formula.

Trial IV2 was based off a published vegan ice cream formulation. Trail IV2 ice cream had an additional 2 grams of protein per serving (versus the published formulation) to make a total of 5 grams of protein per ½ cup serving. The IV2 ice cream had more ice crystals than the IV1 ice cream once frozen. Immediately after processing, the IV2 ice cream had no noticeable differences from traditional ice cream.

Trial IV3 ice cream recipe resembled that of the IV2 ice cream but with additional insoluble pea protein (globular) product instead of soluble pea protein product. This ice cream had an astringent aftertaste sensation. The slurry from this soluble protein product was extremely thick compared to IV2 and nearly too thick for the ice cream maker to process. Not to be limited to theory, an ice cream with 10 grams of protein per serving could be achieved utilizing soluble pea protein product and flavor maskers to overcome the bitterness from the soluble pea protein product.

Carbonated Beverage Applications

TABLE 16
Carbonated Beverage Application Formulations

| Ingredients | CBV1 | CBV2 |
|---|---|---|
| Soluble Pea Protein* | 50 | 0 |
| Water | 1000 | 1000 |
| Anti-Foam | 3 | 0 |
| Pea Protein P870** | 0 | 50 |

*Soluble Pea Protein Product, Experimental
**P870, Insoluble Pea Protein Product, PURIS, Minneapolis, MN

Objective: To determine the feasibility of increasing the protein in a carbonated beverage without compromising the mouthfeel. (Using soluble pea protein product versus insoluble (globular) pea protein product)

Method: For CBV1, the soluble pea protein product was mixed into water until no lumps were observed. Anti-foam was utilized with the soluble pea protein product to prevent excess foaming. Solution was poured into Sodastream® bottle and carbonated utilizing manufacture instructions. For CBV2, the insoluble pea protein product was mixed into water. No further steps were taken since the solution was deemed too thick to utilize in Sodastream®.

Results: Soluble stayed in solution after carbonation and displayed a viscosity similar to that of typical carbonated beverages. Not to be limited by theory, a carbonated beverage with 20+ grams of protein per serving could be made with soluble pea protein product. CBV2, which utilized insoluble (globular) pea protein product was too thick to utilize the Sodastream® and deemed unsuccessful.

Overall, the pea protein products of embodiments of this disclosure (soluble pea protein product and combined soluble and insoluble pea protein product), which could be produced by the method of this disclosure, performed better in various food products than insoluble (globular) pea protein product alone. The pea protein products of embodiments of this disclosure (soluble pea protein product and combined soluble and insoluble pea protein product), were useful in creating many food products without use of allergen ingredients, including wheat gluten, milk proteins, meat proteins, gelatin, and soybean proteins. The pea protein products of this disclosure were_able to be used to create a thick but pourable (i.e., moved when sample was tipped) viscosity high water food products, as well as aerated fluid and solid structure products.

The combined pea protein products of embodiments of this disclosure could be able to be used as direct replacements for meat and dairy based proteins without a drop in the “quality” of the protein in those products because the combined pea protein products can be made so that they have a PDCAAS=0.75-1.0.

The compositions and methods of the present disclosure are capable of being incorporated in the form of a variety of embodiments, only a few of which have been illustrated and described. The disclosure may be embodied in other forms without departing from its spirit or essential characteristics. The described embodiments are to be considered in all respects only as illustrative and not restrictive, and the scope of the disclosure, therefore, is indicated by the appended claims rather than by the foregoing description. All changes which come within the meaning and range of equivalency of the claims are to be embraced within their scope.

What is claimed is:

1. A pea protein product comprising:
a) at least about 40% dry weight pea protein;
b) at least about 90% dry weight of the pea protein is soluble at room temperature at about pH 3-10; and
c) about 0.5-50 dwt % carbohydrate.

2. The pea protein product of claim 1, wherein at least about 60% of the protein has a molecular weight less than about 100 Daltons, less than about 30, preferably less than about 20 Daltons

3. A process of making a pea protein material of claim 2, wherein the process includes the steps of:
a) grinding de-hulled dry peas;
b) mixing the ground peas with water to make a slurry;
c) separating insoluble fiber and starch portions from the protein portions to make an intermediate protein slurry,
d) coagulating the protein to make an insoluble protein in the intermediate protein slurry,
e) neutralizing the insoluble protein in the intermediate protein slurry,
f) optionally, intermixing the neutralized intermediate protein slurry with enzyme,
g) heating the neutralized intermediate protein slurry to about 90-200 F for 5-120 minutes;
h) separating water from the heated neutralized intermediate protein slurry to make a finished insoluble pea protein product and a water solution;
i) filter water solution with filter sized to remove soluble carbohydrates and ash; and
j) further process protein product remaining in water solution after filtering out soluble carbohydrates and ash to create soluble pea protein product.

4. The process of claim 3, wherein an enzyme or a microorganism is further added to the water solution before filtering out carbohydrates.

5. The process of claim 4, wherein the water solution with an enzyme or a microorganism is further filtered to remove carbohydrates.

6. The process of claim 3 uses microfiltration, ultrafiltration, centrifugation or combinations thereof to filter or separate carbohydrates, proteins, ash, or combinations thereof from the water solution.

7. The process of claim 3, wherein further processing of the pea protein remaining in the water solution includes removing at least a portion of the water.

8. The process of claim 3, wherein further processing of the pea protein remaining in the water solution includes combining it with at least a portion of the insoluble pea protein separated from the water portion.

9. The process of claim 8; further processing step is reducing the water content of the combined soluble and insoluble pea protein product.

10. The combined soluble and insoluble pea protein product of claim 9 has a PDCAAS of 0.75-1.00.

11. The process of making a pea protein product of claim 3, comprising soluble pea protein and insoluble pea protein and having a PDCAAS of 0.75-1.0 comprising:
a) making a water insoluble pea protein product;
b) making a water soluble pea protein product; and
c) combining water insoluble pea protein product and water soluble pea protein product in portions such that they have an amino acid profile and digestibility to have a PDCAAS of .75-1.00.

12. A pea protein product that has a molecular weight of about 5 to about 40 Daltons; a solubility of greater than about 70% at pH greater than 4; and a higher sulfur containing amino acid content than insoluble pea protein with a PDCAAS of about 0.75-1.0.

13. A food product containing the soluble pea protein of claim 1, wherein the food product does not contain any animal, egg, gelatin, milk, wheat, or soybean based materials.

14. A food product containing the pea protein product of claim 11, wherein the food product does not contain any animal, egg, gelatin, milk, wheat, or soybean based materials.

15. A food product of claim 13, wherein the food product is selected from a group comprising milks, sports drinks, nutritional beverages, fruit based beverages, carbonated beverages, non-carbonated beverages, non-dairy beverages, acidified hot-fill beverages, Ready-To-Drink beverages, retorted beverages, aseptic packed beverages, gravies, sweet and sour sauces, fermented base sauces (e.g., oyster sauce, soy sauce, teriyaki sauces), broths, tomato based sauces, soups, white sauces, bakery products, meat analogs, cheese analogs, non-dairy products,

16. A food product of claim 14, wherein the food product is selected from a group comprising milks, sports drinks, nutritional beverages, fruit based beverages, carbonated beverages, non-carbonated beverages, non-dairy beverages, acidified hot-fill beverages, Ready-To-Drink beverages, retorted beverages, aseptic packed beverages, gravies, sweet and sour sauces, fermented base sauces (e.g., oyster sauce, soy sauce, teriyaki sauces), broths, tomato based sauces, soups, white sauces, bakery products, meat analogs, cheese analogs, non-dairy products,

17. A pea protein product of claim 1, wherein the pea protein product is used to stabilize a food product against air separation, foam separation, water separation, protein coagulation during heated, ambient, refrigerated and frozen constant and cycling conditions.

18. A pea protein product of claim 1, wherein the pea protein product is used at about 1 dwt % to 99 dwt % protein content in food product to create aeration, cohesion, viscosity, body, solids suspension in meat analogs, cheese analogs, non-dairy yogurts, non-dairy cheeses, non-dairy fermented products, bakery, mousse, confection, coffee topping, ice cream, frozen desert products or combinations thereof.

19. A pea protein product of claim 11, wherein the pea protein product is used to stabilize a food product against air separation, foam separation, water separation, protein coagulation during heated, ambient, refrigerated and frozen constant and cycling conditions.

20. A pea protein product of claim 11, wherein the pea protein product is used at about 1 dwt % to 99 dwt % protein content in food product to create aeration, cohesion, viscosity, body, solids suspension in meat analogs, cheese analogs, non-dairy yogurts, non-dairy cheeses, non-dairy fermented products, bakery, mousse, confection, coffee topping, ice cream, frozen desert products or combinations thereof.
